(19) United States
(12) Patent Application Publication
(10) Pub. No.: US 2005/0076559 A1
(43) Pub. Date: Apr. 14, 2005

(54) Mechanical means pest repellant and plant shield

(76) Inventors: Susan Davis, Escondido, CA (US); Shelton Davis, Escondido, CA (US)

Correspondence Address: Steven W. Webb;Law Offices of Steven W. Webb, 655 2nd Street, Encinitas, CA, 92024, US

(21) Appl. No.: 10/666,427

(22) Filed: Sep. 22, 2003

(51) Int. Cl. A01M 1/18

(52) U.S. Cl. 43/108

(57) ABSTRACT

The invention presented is a mechanical apparatus and method for protecting plants. The apparatus includes a surface which bugs and crustaceans will not crawl up and over. Additionally, the shield is coupled with a wall that extends beneath the surface of the garden and prevents the entrance of gophers and moles. The shield is preferably placed around the border of a garden or located on the surface of a plant pot.

### FIELD OF THE INVENTION

The present invention relates generally to gardening. More specifically, the present invention pertains to devices and apparatus which are capable of separating plants from crawling insects and burrowing animals. The present invention is particularly, but not exclusively, useful as an above-ground shield for warding off crawling bugs and snails and as an underground shield for fending off moles and gophers, is adaptable for use with potted plants or in garden areas.

### BACKGROUND OF THE INVENTION

Caring for a plant or garden requires that pests such as insects, snails, moles and gophers be denied access to the plant or garden.

Various forms of plant protection have been implemented in the U.S. and other countries with varying degrees of success. When assessing forms of plant protection for its suitability for garden purposes, several additional considerations must be taken. The first is human safety. Insect and snail repellants in the market contain chemicals to harmful humans.

Other forms of plant protection can be time consuming, cumbersome, and expensive. Many pest repellents require reapplying the mixture to the plant after a certain amount of time passes or after a few short rain storms.

Storage of plant protection can be cumbersome. The user must store unused portions of insect powder and the bucket or storage container in what is, for some gardeners, sparse and valuable garage or garden shed shelf space.

Also, stored powder in a garden shed or garage can present a poisoning danger to small children and family pets.

Other forms of plant protection offered on the market such as copper guard railings are not considered aesthetically adequate to all users. In general, it is desirous for a bug guard to be inconspicuous.

### OBJECTS OF THE INVENTION

It is an object of this invention is to provide an insect, crustacean, mole and gopher shield which is appropriate for plants and protective of the environment. Another object of this invention is to provide a system which is aesthetically pleasing.

It is a further object of this invention to provide a system that may be configured for protecting potted plants or various sizes of gardens.

It is a further object of this invention to provide a system which is easy to implement and comparatively cost effective.

It is a further object of this invention to provide a pest repellant system that has low toxicity to humans and small impact on the environment.

### SUMMARY OF THE INVENTION

The plant shield device comprises a shield element having a front surface and a back surface. The back surface faces a plant. The shield element is flexible and may be formed into smooth curvilinear transitions or a variety of shapes to shape to the circumference of a garden or perimeter of a plant pot.

The plant shield also comprises an above-ground section and an underground section. The underground section has a bottom edge with a plurality of ridges or grooves that are for engaging the shield into the ground.

A method and device in accordance with the present invention shall include an array of several shield sections. Each section is substantially rectangular having an above-ground section that is approximately 2 cm to 15 cm in height and 2 mm to 2 cm thick. The material which comprises the shield will also clearly effect the operation of the shield. For simplicity, the surface of the shield is defined as one that bugs will not crawl up and over. When the shield is placed around a plant, it is able to effectively fend off crawling bugs, crustaceans, moles, gophers and other pests.

### BRIEF DESCRIPTION OF THE DRAWINGS

The features of this invention will be best understood from the accompanying drawings, taken in conjunction with the accompanying description.

FIG. 1 is a front view of the shield

FIG. 2 is a top view of one section of the shield

FIG. 3 illustrates the shield positioned on a potted plant;

FIG. 4 illustrates a second embodiment of the shield attached to a pot with a brush or spray

FIG. 5 is a close-up of the shield embedded in the ground

FIG. 6 illustrates how the shield material is applied to a pot

FIG. 7 shows the shield in a roll from which sections can be detached

FIG. 8 shows the shield arranged in a box

FIG. 9 Shows two sections of the shield with fold/perforations

FIG. 10 is a top view of the shield arranged in a box shape

FIG. 11 is a cross-section of the shield inserted into the ground

FIGS. 12, 14, 15, and 16 are alternate embodiments of the fold between sections

### DESCRIPTION OF THE PREFERRED EMBODIMENT

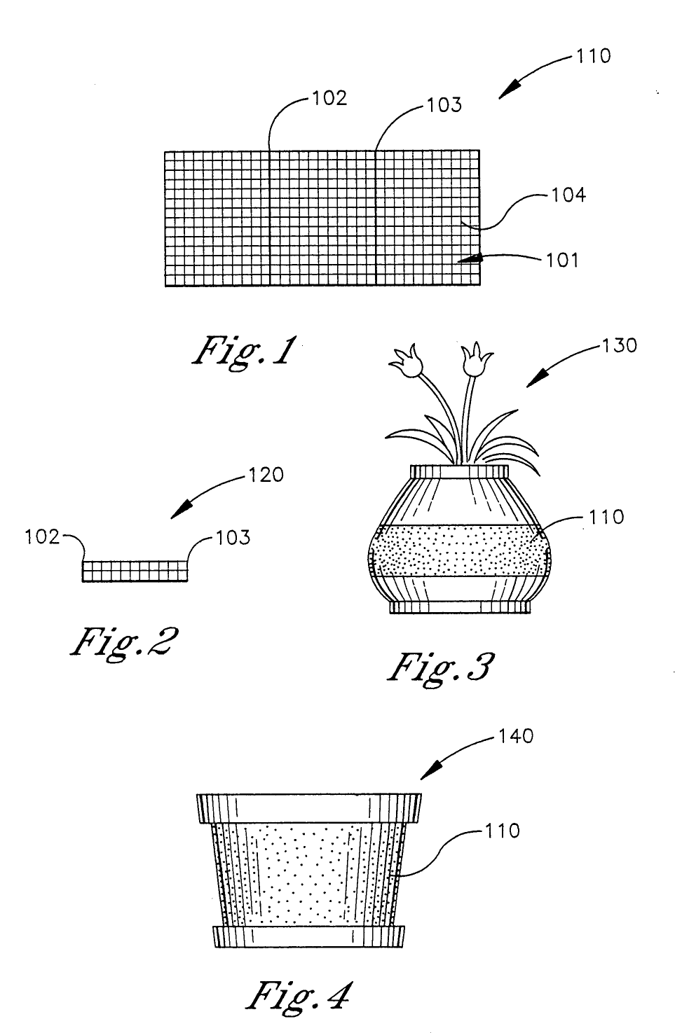

The present invention comprising an insect and pest shield system for gardens¹⁰⁰, is seen in FIG. 1 as a flat piece of material ¹¹⁰ with a front surface¹⁰¹ with folds/perforations ^{102,103} and possessing a sticky abrasive substance¹⁰⁴ on the surface^{10l}. The other side of the material ¹²⁰ is flat and smooth. The flat piece of material ¹¹⁰ is made from a flexible substance that is semi-rigid and can be molded or cut into shape.

The sticky abrasive substance¹⁰⁴ is a combination of sand or grit plus an adhesive that can be brushed or sprayed onto the front surface ¹⁰¹ of the invention¹⁰⁰, or the invention ¹⁰⁰ can be purchased with the sticky abrasive substance¹⁰⁴ already applied.

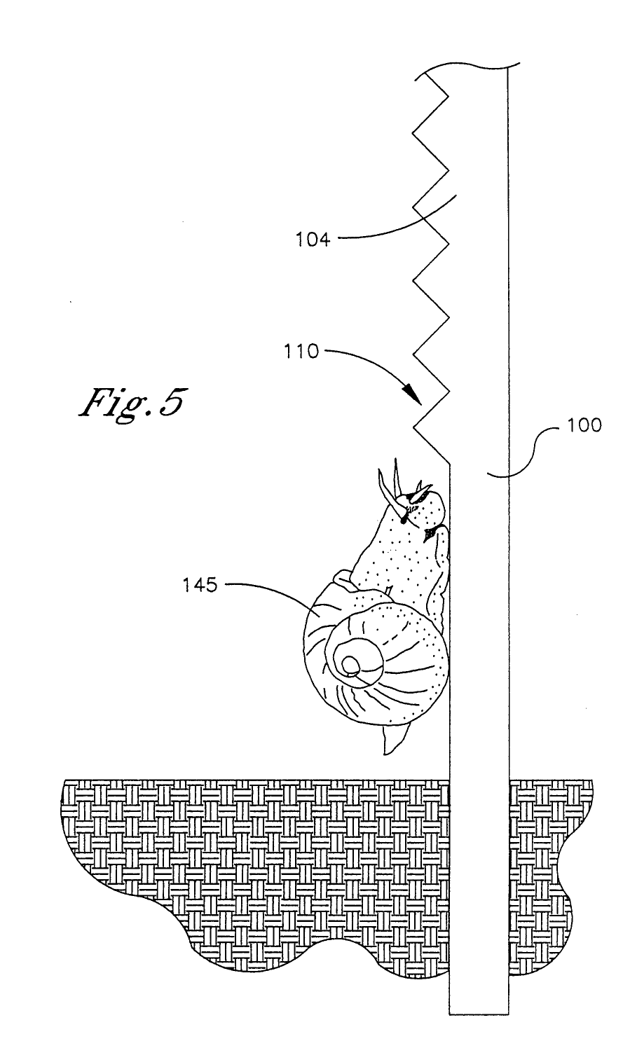

The invention¹⁰⁰ can be flexible enough to be wrapped around a potted plant¹³⁰ as shown in FIG. 3. or the sides of a pot ¹⁴⁰ as in FIG. 4.

The mechanical action of the sticky abrasive substance¹⁰⁴ is shown in FIG. 5, where a snail ¹⁴⁵ is prevented from crawling up the side of the invention¹⁰⁰ by the presence of the substance¹⁰⁴ above it. Snails will not cross rough surfaces that tear their “foot”. Many insects are also discouraged from crossing rough surfaces because it hurts their undersides. Note that the invention is also sunk into the ground.

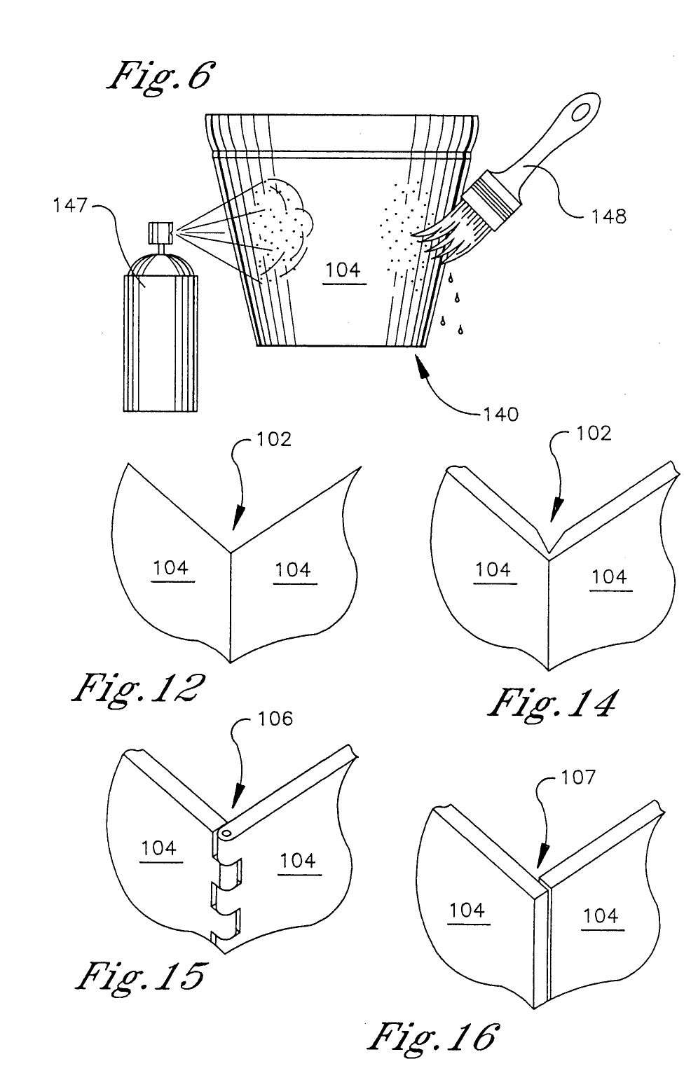

FIG. 6 illustrates the application of the sticky abrasive substance to the side of a pot¹⁴⁰. A spray mechanism¹⁴⁷ or brush¹⁴⁸ can be used to apply the substance¹⁰⁴ to a flat or smoothly curved surface.

FIGS. 7, 8, and 9 show how the invention can be distributed as a roll¹⁵⁵ from which sections ¹⁵¹ of the necessary length can be torn. They also show how the invention can be folded along the fold/perforations ¹⁰². The bottom edge of the invention ¹⁵⁶, possessing none of the sticky abrasive substance¹⁰⁴ is ridged as shown to make it easy to insert into the ground around plants.

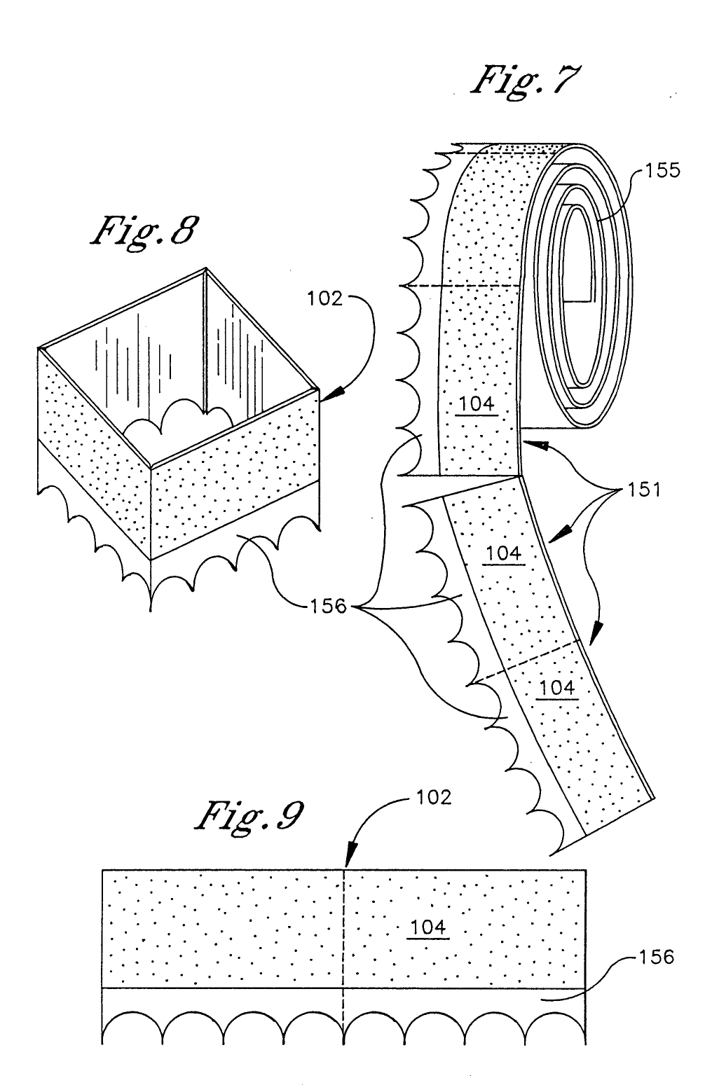

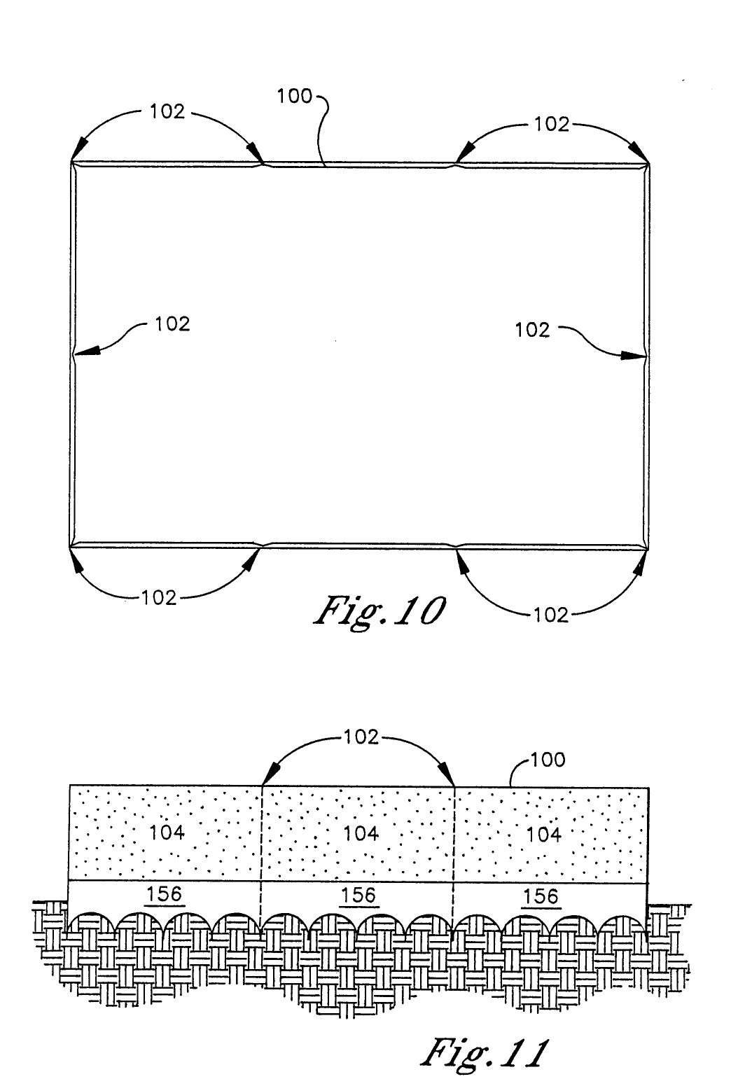

FIG. 10 is a top view of how a length of the invention ¹⁰⁰ can be folded along the fold/perforations ¹⁰² to form a rectangular barrier. FIG. 11 is a cross section of the invention ¹⁰⁰ inserted into the ground.

FIGS. 12, 14, 15, and 16 show alternative embodiments of the invention with alternate means of joining the sections, including hinges and snap-together connectors.

While the foregoing describes a preferred embodiment, variation on this design and equivalent designs may be resorted to in the scope and spirit of the claimed invention.

1. (canceled)

2. (canceled)

3. (canceled)

4. (canceled)

5. A method of applying a sticky abrasive substance to an exterior surface of a plant reservoir, the method comprising placing the shield element in contact with a surface of a plant reservior.

6. (canceled)

7. An insect and pest shield system for gardens comprising a plurality of shield elements, each shield element in a roughly rectangular planar shape having a front surface and an opposing back surface, wherein the front surface and the opposing back surface are flat,
each shield element possessing a top edge and a bottom edge, the bottom edge of each shield element shaped in sharp ridges, the bottom edge of each shield element capable of being inserted into the ground with manual pressure, the top edge of each shield element a smooth straight edge,
the front surface of each shield element covered partially with a sticky substance with embedded grit, the sticky substance with embedded grit confined to each shield element front surface,
the plurality of shield elements connected to each other as a single sheet of material, each shield element separated from the other by means of perforations in the single sheet of material,
whereby is provided a system of plant protection that is easy to manufacture, is flexible enough to conform to any garden area to be protected, and is easy to install.
